(19) United States
(12) Patent Application Publication
(10) Pub. No.: US 2016/0253633 A1
(43) Pub. Date: Sep. 1, 2016

(54) SYSTEM AND METHOD OF GENERATING HOME REPAIR REPORTS

(71) Applicants: Kevin EPSTEIN, Phoenix, AZ (US); Alan SCHULMAN, Playa Vista, CA (US)

(72) Inventors: Kevin EPSTEIN, Phoenix, AZ (US); Alan SCHULMAN, Playa Vista, CA (US)

(21) Appl. No.: 15/054,735

(22) Filed: Feb. 26, 2016

Related U.S. Application Data
(60) Provisional application No. 62/121,074, filed on Feb. 26, 2015.

(51) Int. Cl. G06Q 10/00; G06Q 50/16; G06Q 30/02

(52) U.S. Cl. CPC G06Q 10/20; G06Q 30/0283; G06Q 50/163

(57) ABSTRACT

A method of generating home repair estimate reports from subjective home or other building inspection reports may be provided. Such a method may allow preliminary high-level estimation of building repair costs, and may require uploading the inspection report and building and location data, generating a calibration model and location indexing information, extrapolating the sectional deficiencies identified in the inspection report, mapping the deficiencies to the building model, and applying the indexing information.

### CROSS-REFERENCE TO RELATED APPLICATIONS

This application claims priority from U.S. Provisional Patent Application No. 62/121,074, filed on Feb. 26, 2015, entitled “System and Method of Generating Home Repair Reports,” the entire contents of which are hereby incorporated by reference.

### BACKGROUND

A savvy prospective buyer of a home understands that not every home is going to be perfect, and that the actual value of a home can change drastically depending on how far off the home may be from that ideal. Because of this, sales of homes are often predicated on the completion of a home inspection by a qualified expert and the submission of a home inspection report to the buyer detailing all of the defects that the home inspector observed on a cursory walk-through of the home.

Similarly, many current owners of homes may occasionally desire to have their homes inspected. This may be to identify what parts of the home need repairs or preventative maintenance, or may be in order to get the house in better condition in order to sell it later on.

However, such reports have limitations. Typical home inspection reports disclose only the components that a home inspector has identified to be faulty, damaged or otherwise defective, and generally do not provide to a recipient any indication about the costs involved in remedying those defects. Many reports recommend, even for an initial estimate, that the recipient of the report have each component that was identified by the inspector to be defective inspected by a qualified professional in the appropriate field. If a buyer opts to do this, it can dramatically increase their costs and time investment in a particular property; if they do not do this, or attempt to calculate an estimate themselves with the information they have available, it may lead to poorer purchasing decisions. An intermediate solution may therefore be desired.

### SUMMARY

According to an exemplary embodiment, a method for generating home repair estimate reports may be described. Such a method may comprise: storing, on a memory, building data characterizing at least one building, wherein the building data comprises subjective building inspection data, physical building data, and property location data; generating, on a memory and with a processor, from the subjective building inspection data, sectional deficiency data comprising at least one of a sectional deficiency and a potential sectional deficiency; generating, on a memory and with a processor, from the building data, a model of the at least one building; generating, on a memory and with a processor, from the building data, a plurality of index factors; generating, on a memory and with a processor, using at least one of the sectional deficiency data, the model of the at least one building, and the plurality of index factors, a plurality of repair cost estimate reports, comprising a master repair cost estimate report and a shared repair cost estimate report, and comprising an official repair cost estimate report and an unofficial repair cost estimate report; storing, on a memory, the plurality of repair cost estimate reports; storing, on a memory, a credential of a user authorized to access the official repair cost estimate report; receiving a request for the official repair cost estimate report containing the credential of the user; providing a repair cost estimate report viewer application to the user; and sending a notification to the repair cost estimate report viewer application; wherein the notification activates the repair cost estimate report viewer application to cause the official repair cost estimate report to display on the repair cost estimate report viewer application.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 shows an exemplary embodiment of a flowchart diagram detailing a process by which a subjective building inspection report may be transformed into a detailed repair costs report.

FIG. 2 shows an exemplary embodiment of a flowchart diagram detailing a process by which a subjective building inspection report may be transformed into a detailed repair costs report.

FIG. 3 shows an exemplary embodiment of a flowchart diagram detailing a process by which a subjective building inspection report may be transformed into a detailed repair costs report.

FIG. 4 shows an exemplary embodiment of a flowchart diagram detailing a process for completing the step of site calibration and index factor assignment.

FIG. 5 shows an exemplary embodiment of a building profile table.

FIG. 6 shows an exemplary embodiment of a flowchart diagram detailing a process for completing the step of extrapolating sectional building deficiencies.

FIG. 7 shows an exemplary embodiment of a sectional deficiency table.

FIG. 8 shows an exemplary embodiment of a flowchart diagram detailing a process for completing the step of sectional repair cost assignment and index adjustment.

FIG. 9 shows an exemplary embodiment of an official repair cost report.

FIG. 10 shows an exemplary embodiment of a flowchart diagram detailing a process for authenticating access to official and unofficial versions of a master version of a repair cost estimate report.

FIG. 11 shows an exemplary embodiment of a flowchart diagram detailing a process for authenticating access to official and unofficial versions of a shared version of a repair cost estimate report.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

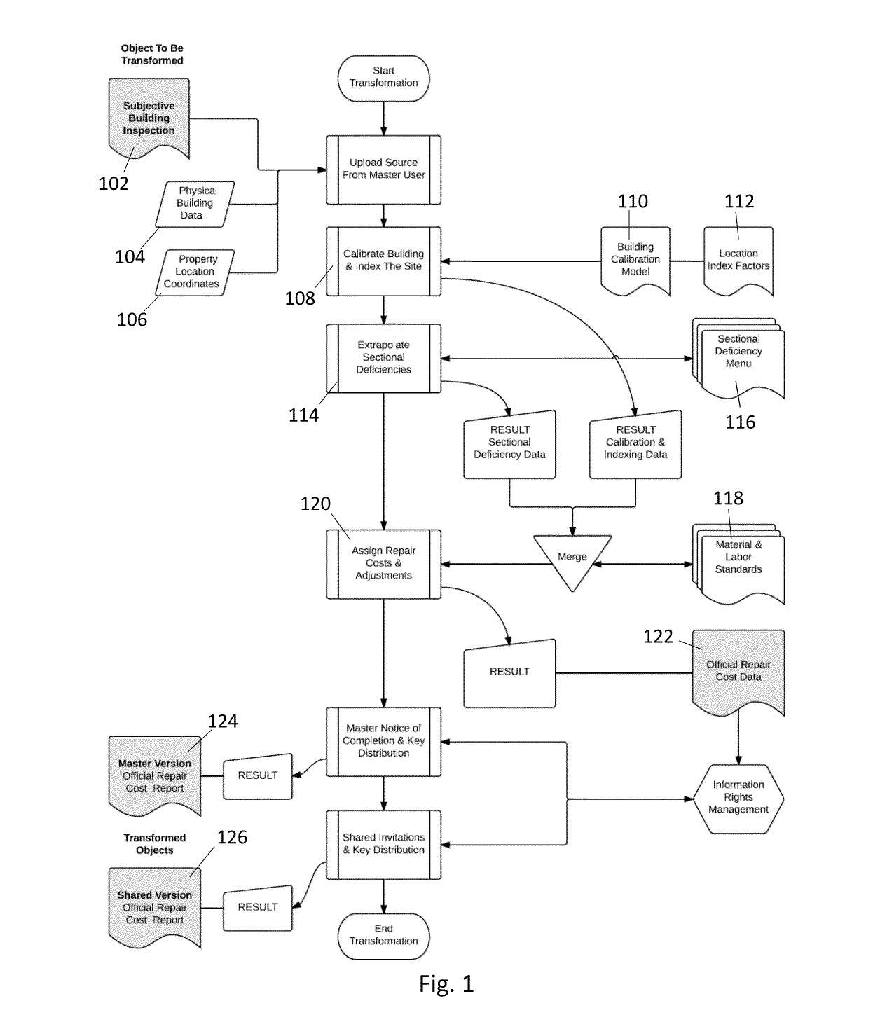

Referring now to exemplary FIG. 1, a flowchart diagram 100 may describe an exemplary process by which a subjective building inspection report 102, in conjunction with other data, may be used to generate a report detailing high-level cost estimates for mitigating or fixing any or all of the defects identified in the subjective building inspection report 102. A processor or memory may be configured to receive data from user input or from another source; such data may include all or part of the subjective building inspection report 102, as well as any other physical building data 104, the coordinates of the property or any other information about the location of the property 106, or any other information desired. The data received by the processor and/or memory may also include user credentials. For example, access or modification rights for the uploaded data may be restricted to one or more master user accounts, and the processor and/or memory may be configured to reject requests that are not associated with these user accounts' credentials.

According to an exemplary embodiment, the processor and/or memory may then be configured to perform a calibration and indexing procedure 108. This may constitute generating a model 110 of the building or buildings that the subjective building inspection report 102 covers, as well as generating a number of index factors 112 relating to the location of the building. The processor and/or memory may then be configured to extrapolate a number of sectional deficiencies 114 or potential sectional deficiencies from the subjective building inspection data 102. This information may then be combined with the calibration model 110, the index factors 112, and/or any relevant material and labor standards 118 with which the building may need to comply, and used to generate an estimate of the repair costs and adjustments 120 involved with correcting any or all of the previously extrapolated sectional deficiencies 114 and bringing the building up to its desired state.

The estimates of the repair costs 120 may be used to generate a comprehensive cost assessment report 122 detailing all of the necessary modifications and the costs required to install or make those modifications. Report 122 may be available in multiple versions. According to one exemplary embodiment, a comprehensive master version of the report 124 and a less-detailed shared version of the report 126 may both be generated; alternatively, both reports may be equally detailed, or otherwise detailed, as desired. Access to the master version 124 may be controlled by distribution of the appropriate credentials, such as a master key, or may be controlled by extending permission to access the master version to previously generated user accounts, or as desired. Access to the shared version 126 may be similarly controlled, for example by distribution of credentials; according to one embodiment, a user with access to the master version of the report 124 may be able to authorize access to the shared version for a limited or unlimited number of users or user accounts.

A distinction may also be made between “official” and “unofficial” cost assessment reports 122. According to an exemplary embodiment, identical or substantially identical reports may be displayed to both users with access to the master version of the report 124 and to the shared version of the report 126. However, official cost assessment reports 122 may be maintained exclusively online, while any printed or hard copies of the report may be classified as unofficial. This may ensure that all parties are able to access the same information by accessing the official report, which may help to prevent fraud. It may also ensure that all parties that desire access to the official report must gain access through the service instead of by receiving an unofficial hard copy from another user, which may encourage subscriptions to the service.

An exemplary embodiment of a method of controlling access to the official and the unofficial cost assessment reports may require the use of a computer. It may be recognized that, if one or more parties has access to and the ability to modify the official cost assessment report, one or more of the parties that has access to the report may seek to alter it to their advantage. For example, an unscrupulous contractor, or unscrupulous party that has partnered with a contractor, may seek to alter the report to overstate the cost of a repair, so that they can then sell a “special deal” to the property owner that is still more expensive than the true cost of performing the repair. In another example, a property owner may seek to alter the report to understate the cost of a needed repair in order to boost the sale price of the property. An advantage of a method of controlling access to the official and the unofficial cost assessment reports in which the official cost assessment report is only accessible using a computer may be that the official cost assessment report can be maintained in such a form that no human has access to the original.

For example, according to one exemplary embodiment, the official cost assessment report may be encrypted using public-key cryptography. The official cost assessment report may be encrypted using a private key, which may be used once and then discarded. Public keys may then be given out to users with access. This may ensure that the official cost assessment report can be freely viewed after being created, but cannot be altered, even by a party having access to the database or other storage medium on which the official cost assessment report is stored. According to another exemplary embodiment, the key may be retained by the software, and the software may, for example, permit certain types of modifications to the official cost estimate report while forbidding other types of modifications to the official cost estimate report. For example, according to an exemplary embodiment, the official cost estimate report may be modifiable only within a certain time period. According to another exemplary embodiment, the software may have a means of evaluating proposed modifications, and modifications may be made to the official cost estimate report by proposing modifications and having them be approved by the software. Other exemplary embodiments that may limit or bar the ability of a human to modify or assert control over the official cost estimate report may also be understood.

Alternative versions of the report may also be envisioned. According to an exemplary embodiment, different tier levels of the service, such as a “free” and “premium” version, may be offered. If a report is generated or if a process intended to generate a report is triggered, and the processor and/or memory contains or detects information that identifies that the executing user has access to a lower tier of service, a less informative report may be generated than would be the case if the user had been subscribed to a higher level of service. Alternatively, other features may be present in higher tiers of service and absent from lower ones. For example, a user with access to a lower tier of service may only be able to generate a limited number of reports in a given timeframe. As another example, a user with access to a higher tier of service may be directly provided with an exhaustive list of qualified professionals in the area that may be able to provide them with assistance, while a user with access to a lower tier of service may not be able to access such a list or may be able to access a list populated only with those professionals who have advertised. According to yet another embodiment, a user with access to a higher level of service may be able to access the report much more quickly than a user with access to a lower level of service. Alternatively, a charge may be levied for access to the report, and this cost may be set depending on factors like the user's needs, for example based on how quickly the report must be provided.

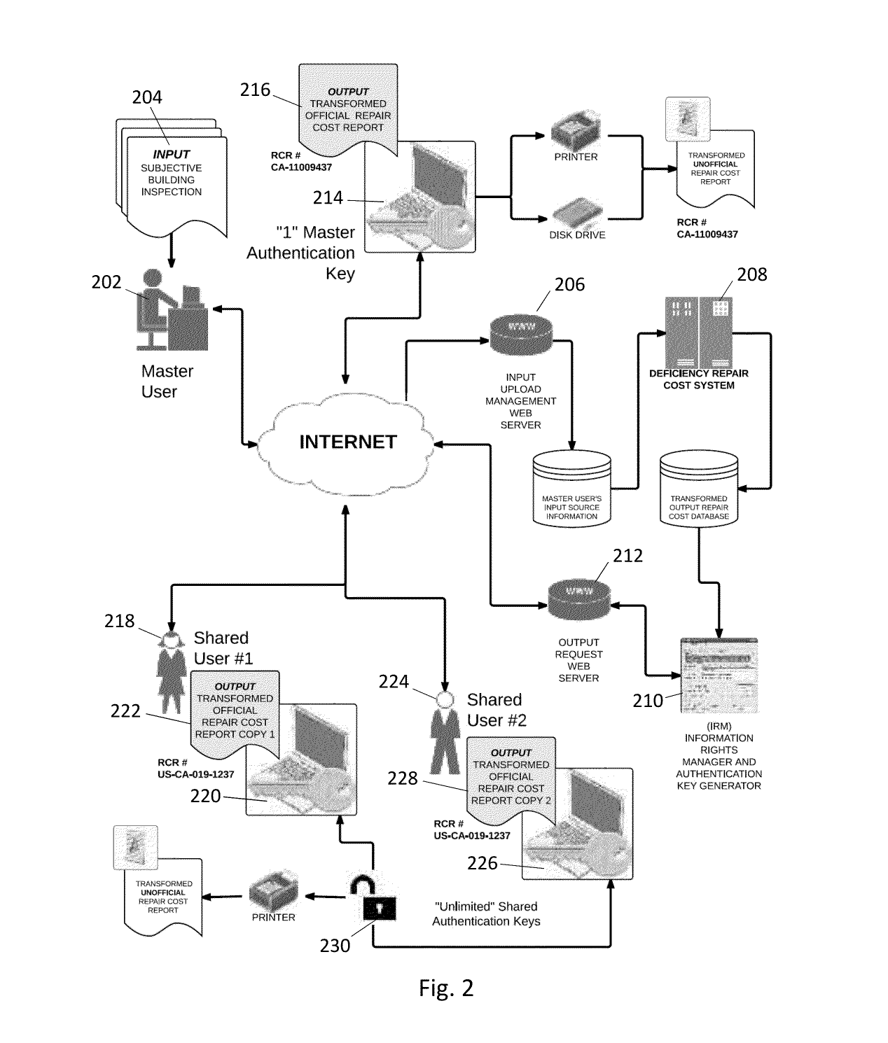

Referring now to exemplary FIG. 2, a flowchart diagram 200 describes an alternative embodiment of a process that may be used to generate a report detailing high-level cost estimates. A master user 202 may input or upload data, such as subjective building inspection data 204, into an input upload management web server 206 configured to receive such data. This user-inputted data 204 may then be combined with other data, such as public data about a building or location, the public laws and building codes of the jurisdiction in which the building is located, or other data, and submitted to a deficiency repair cost system 208. It may be noted that the public data may be accessed from any of a variety of public or private databases automatically, depending on desired conditions. Deficiency repair cost system 208 may be an expert system, a set of static rules, or another variety of decision-making system, as desired. Deficiency repair cost system 208 may then analyze the data submitted by the user 204, the public data, and any other data available to it, such as corrections or clarifications submitted by previous users of the service, and may then use that data to generate repair cost assessment data.

According to an exemplary embodiment, deficiency repair cost system 208 may make use of any of a variety of estimation tools or techniques. For example, according to an exemplary embodiment, the deficiency repair cost system 208 may analyze data and make estimations based on “expert judgment,” wherein historical information is used to give future estimates. Expert judgment may also include, for example, using historical information to select between or reconcile different estimating methods. According to another exemplary embodiment, analogous estimating may be used; analogous estimation may use a measure from one (or a small number) of previous similar projects to estimate the same measure (for example duration or cost) in the current project. According to another exemplary embodiment, parametric estimating may be used; parametric estimation may use an algorithm to estimate the measure from one or a small number of previous similar projects to estimate the same measure in the current project. According to another exemplary embodiment, “bottom-up” estimation may be used; “bottom-up” estimation may include breaking a project down into its smallest components, making estimations for each of them, and then reconstructing the project. According to another exemplary embodiment, three-point estimating may be used; three-point estimating may include making a best-case assumption, a worst-case assumption, and an average or most-likely-case assumption, and then combining the estimates. Estimates may be combined by using, for example, the triangular distribution formula or the beta distribution formula.

According to an exemplary embodiment, deficiency repair cost system 208 may make use of different estimation tools or techniques for different components. For example, according to an exemplary embodiment, parametric estimation may be used where there is a clear statistical relationship between historical data and variables; for example, it may be used to estimate the cost per square foot of painting a wall. Analogous estimation may be used where there is a clear analogous relationship between historical data and the current variable, or when greater speed is desirable; for example, it may be used to estimate the cost of replacing an off-the-shelf component, or may be used to estimate the cost of less expensive repairs that will have less of an effect on the final result.

Repair cost assessment data may then be passed to an information rights manager and authentication key generator 210 or similar information management device (hereinafter “IRM”). IRM 210 may identify which, if any, users are entitled to a master authentication key 214, and which, if any, users are entitled to a shared authentication key 220, 226. Master authentication key 214 may be passed to the master user 202 and any other authorized persons, and may be used to access the comprehensive version of the transformed official repair cost report 216. Shared authentication keys 220, 226 may be passed to shared users 218, 224, and may be used to access a shared version of the transformed official repair cost report (“repair cost report”) 222, 228. Different copies of the repair cost report 222, 228 may be identical, may contain different information or presentations of information that are specifically tailored to the shared users 218, 224 to whom shared authentication keys 220, 226 were sent, or as desired. According to an exemplary embodiment, multiple types of shared users 218, 224 may be supported.

Different versions can be made available 222, 228 because individual shared users 218, 224 may have distinctive needs. Each shared repair cost report 222, 228 can be tailored in order to better meet the specific needs of shared users 218, 224. According to an exemplary embodiment, specific tailoring of shared versions of the repair cost report 222, 228 may be accomplished by configuring the authentication keys 220, 226 created by the processor and/or memory to create explicit versions based on the various individual needs of the shared users 218, 224. For example, branching logic may be used to evaluate the preset known or desired needs of shared users 218, 224 with the logical operators “AND”, “OR” and “NOT” in the database architecture to make inclusions or exclusions of certain elements, tailoring the specifics for various shared users 218, 224 for any shared repair cost report 222, 228.

Once the IRM 210 has established which, if any, users are entitled to master authentication key 214 and which, if any, are entitled to shared authentication keys 220, 226, the output request web server 212 may be configured with this information. It may be appreciated, in some exemplary embodiments, that shared authentication keys 220, 226 or even shared access to repair cost report 222, 228 may be varied based on a first time of access of a user with a master authentication key 214, or access settings manipulated by a user with a master authentication key 214. Upon user request and when such request is made using the appropriate authentication key, the output request web server 212 may be configured to provide to the requestor the appropriate version of the repair cost report 216, 222, 228. According to some embodiments, processing of the user request may be handled by the output request web server 212 directly, by the IRM 210, or by another component of the system such as the input upload management web server 206.

The IRM 210 may identify and distinguish between master users 202 that are entitled to a master authentication key 214, and shared users 218, 224 that are entitled to a shared authentication key 220, 226. According to an exemplary embodiment, only one master authentication key 214 may exist, and it may be provided to the preparer of the report or another master user 202 in such a manner that it is uniquely associated with the master user 202. For example, it may be permanently associated with a user account of the master user 202, and may be linked to the user account of the master user 202 by requiring the master user 202 to log into or create an account before using the service. According to another exemplary embodiment, a master authentication key 214 may be made available upon provision of some credential of the master user 202. According to another exemplary embodiment, multiple master users 202 may have master authentication keys 214.

The master authentication key 214 may, when provided, have different functionality than the shared authentication key 220, 226. For example, according to one exemplary embodiment, a user that provides the master authentication key 214 may be able to print an unofficial repair cost assessment report or may be able to save an unofficial repair cost assessment report to a disk drive, while a user that provides the shared authentication key 220, 226 may only be able to print an unofficial repair cost assessment report. According to another exemplary embodiment, a shared user 218, 224 may be required to perform an additional unlocking step 230, such as an additional authorization step or a monetary payment, before an unofficial repair cost assessment report will be made available to be printed.

According to an exemplary embodiment, unlocking step 230 may include requiring a shared user 218, 224 to request that the report be shared. A shared authentication key 220, 226 may then be provided to the shared user 218, 224. In an exemplary embodiment, the master user 202 may control access to the shared authentication key 220, 226, and may be able to approve, deny, or block requests, as desired. Master user 202 may also be able to grant access to shared users 218, 224 without the need for the shared user 218, 224 to send a request, if desired. According to another exemplary embodiment, access may be available to shared users 218, 224 that have created log on credentials or a user account for a service on which the unofficial repair cost assessment report is hosted; the shared user 218 may be able to gain access and may be provided with a shared authentication key 220, 226 upon creating or inputting their log in credentials, or as desired.

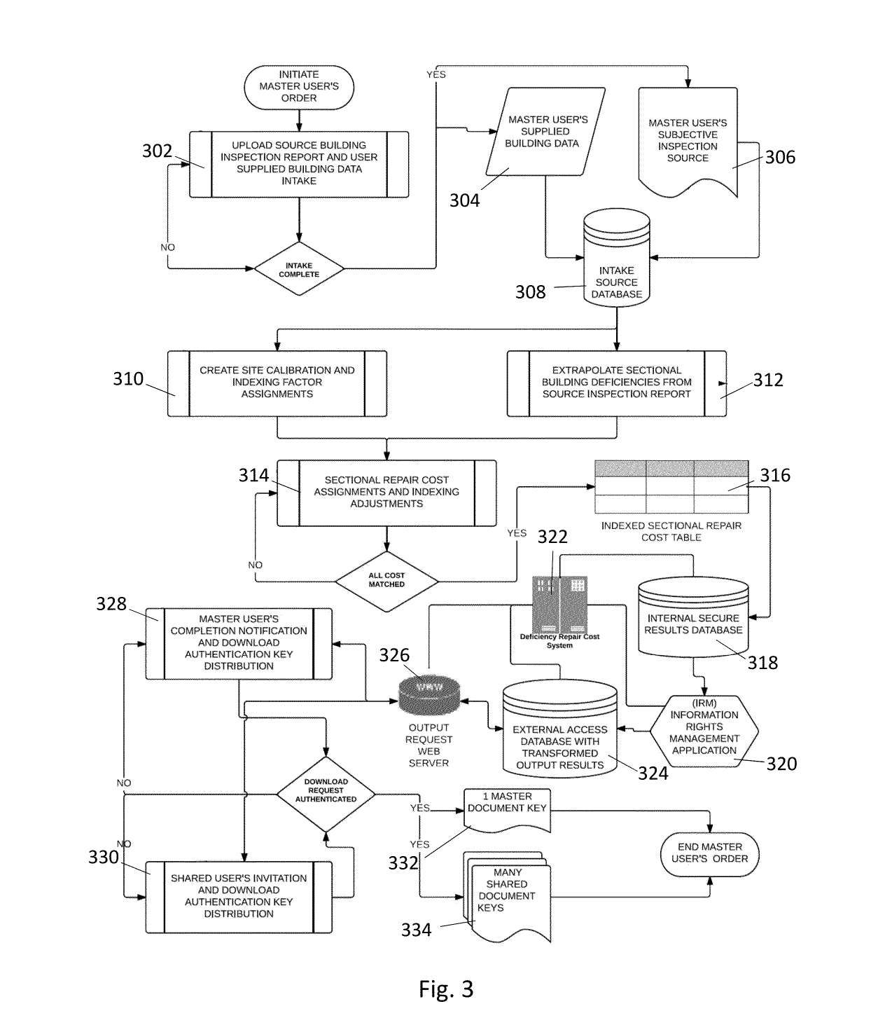

Referring now to exemplary FIG. 3, a flowchart diagram 300 can describe an alternative embodiment of a process that may be used to generate a report detailing high-level cost estimates. A processor and/or memory may receive, via user upload, a building inspection report for a source building, as well as any other user-supplied data intake 302. The processor and/or memory may loop until all appropriate data has been uploaded or input, and may request further input from the user if all appropriate data has not yet been made available to it. Once all appropriate data has been uploaded, the data may be split into the data directly supplied by the master user 304 and the data supplied by the subjective inspection source 306 (such as an uploaded subjective building inspection report), and may be supplied in these forms to an intake source database 308.

A processor and/or memory operationally linked to the intake source database may then perform a site calibration and index factor generation and assignment procedure 310. This may include generating a site model and any appropriate index factors corresponding to the location of the site. The processor and/or memory may also be configured to extrapolate any sectional building deficiencies 312; extrapolation of sectional building deficiencies 312 may be based on, for example, the source inspection report 306 or any other available data. According to an exemplary embodiment, extrapolation of sectional building deficiencies 312 may include applying an evaluation testing technique and returning a binary result, such as a “True” or “False” condition, based on the result of the evaluation testing technique. For example, according to one exemplary embodiment, the processor and/or memory may be configured to return a “True” condition upon conducting an evaluation testing technique of any component of the source inspection report 306, and identifying the presence of an unsafe condition, improper functionality, a local building code violation, a missing part, or damage to the component, or identifying that the component is nearing or is at the end of its service life. The processor and/or memory may be configured to return a “False” condition upon conducting an evaluation testing technique of any component of the source inspection report 306 and not identifying a problem that would cause a “True” condition to be returned. Alternatively, according to an exemplary embodiment, the processor and/or memory may be configured to return a “False” condition upon identifying the absence of an unsafe condition, improper functionality, a local building code violation, a missing part, or damage to the component, or identifying that the component is near the beginning of its service life.

The site model and index factors 310, along with the deficiencies identified from and extrapolated from the source inspection report 312, may then be combined, and, based on the site model 310, the sectional repair costs 314, or costs to remedy each deficiency to the standard desired by the user, may be identified and assigned. The processor and/or memory may iterate through all of the known deficiencies 312 until sectional repair cost information relating to each of the known deficiencies 314 has been assigned. The processor and/or memory may also update or adjust the index factors corresponding to the location of the building, as desired.

According to one exemplary embodiment, sectional repair cost assignments 314 may be stored in the form of an indexed sectional repair cost table 316, or in another desirable form. This table 316 may be stored within a larger internal secure results database 318. Database 318 may be retained by the service provider and used to retain one or more such tables 316 corresponding to one or more different master users. Database 318 may be secured and may allow access to or downloading of results only with the proper authentication key. Access to the database 318 may be controlled by an IRM application 320. Evaluation and transformation of this data may be effected by a deficiency repair cost system 322. According to one exemplary embodiment, the nature, scope, and severity of each deficiency identified by the subjective building inspection report and the sectional repair cost data stored in the indexed sectional repair cost table 316 may each be passed to the deficiency repair cost system 322, as well as any other information desired. The deficiency repair cost system 322 may then calculate, based on the deficiency information from the subjective building inspection report and the repair cost information 316, the estimated cost to repair each deficiency. According to other embodiments, the deficiency repair cost system 322 may also make other estimations, such as the number of man-hours necessary to make the repairs.

Deficiency repair cost system 322 may be linked to the internal secure results database 318, to the IRM 320, to an external access database configured for storing transformed output results 324, or to an output request web server 326. Data may be passed between the deficiency repair cost system 322 and any or all of these linkages, as desired. According to one embodiment, external access database 324 may store any results that may be directly accessed by a user, for example an indexed and browsable list showing each deficiency and the estimated cost to repair each deficiency, or a transformed official repair cost report or multiple versions of said report. External access database 324 may store only the transformed results, for example to reduce the necessary storage capacity of the external access database 324, or to reduce file size and increase access speed. Internal secure results database 318 may store all data, including the transformed results produced by the deficiency repair cost system 322, or may only store the data input to the deficiency repair cost system or only another portion of the data, as desired.

Output request web server 326 may be configured to receive requests from authorized master users 328 or authorized shared users 330; requests may be contingent on the provision by those users of a master document key 332 or a shared document key 334 upon request by the output request web server 326.

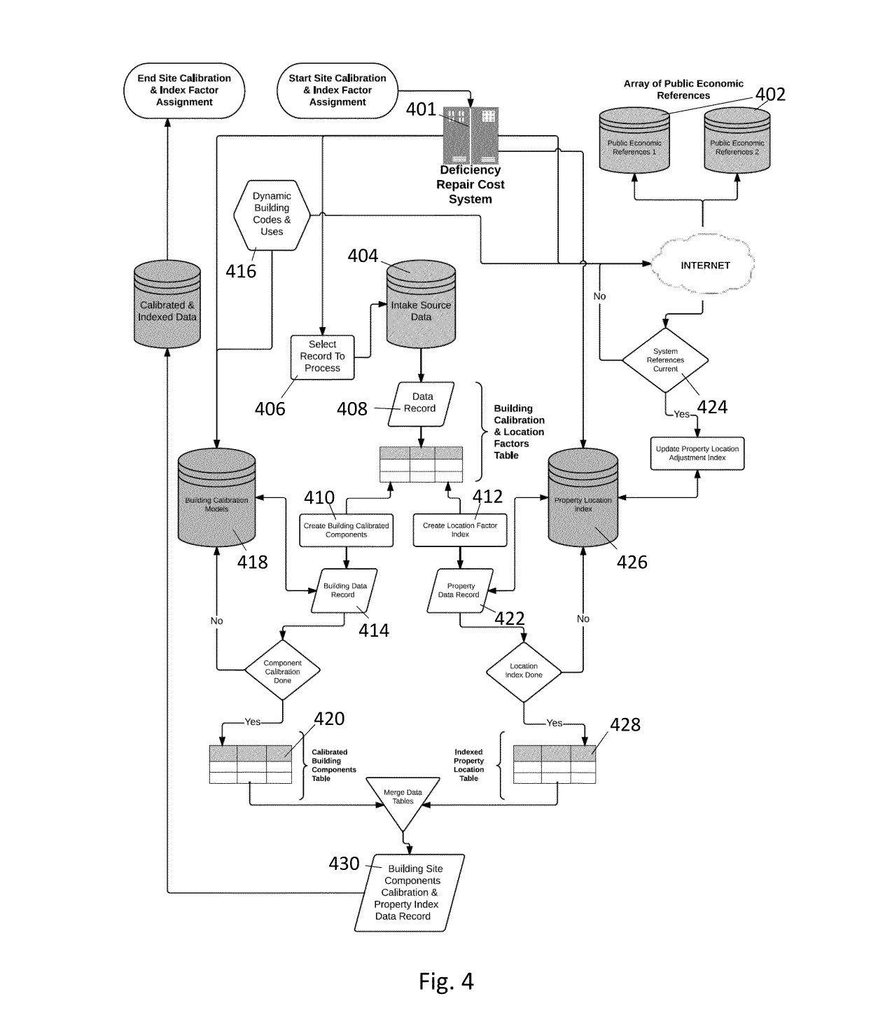

Referring now to exemplary FIG. 4, a flowchart diagram 400 describes an embodiment of a process that may be used to complete the step of site calibration and index factor assignment. A deficiency repair cost system 401 may select from data made available to it, which may include, for example, public economic reference data 402 and the intake source data 404 provided by a master user. According to an exemplary embodiment, deficiency cost system 401 may use a stepping process of data analysis, and may loop through each value from the intake data source 404 to find a comparative match or association. Deficiency cost system 401 may then calculate an arithmetic numeric ratio value to a public economic reference 402. The arithmetic numeric ratio value may be stored in a memory as a temporary record; temporary record may then be used to create a new data record 408 based on building data and building location data disclosed in the intake source data 404.

According to an exemplary embodiment, deficiency repair cost system 401 may first be used to select a record to process 406 from the intake source data 404. Data record 408 may be stored in a memory in the form of a building calibration and location factors table, which may be configured to allow building calibrated component data 410 and location factor data 412 to be accessed, modified, added, or removed from the table, as desired. Building calibrated component data may be used in conjunction with building data records 414, building code data 416 taken from the Internet or otherwise accessed or generated by the deficiency cost repair system 401, and any other pertinent data to generate building calibration models 418. Once the building calibration models 418 have been fully generated, data regarding the calibrated building components may be passed to a calibrated building components table 420. Similarly, location factor data 412 may be used in conjunction with data records regarding the property in question 422, with various locally-stored system references regarding the location that the property is in 424, with references retrieved from the Internet or from another location, or with any other data available to the deficiency cost repair system 401 to generate property location index data 426. Once the property location index data 426 has been fully generated, it may be passed to an indexed property location table 428.

Calibrated building components table 420 and indexed property location table 428 may, when both have been completed or earlier, be merged into a single building site components calibration and property index data record 430. Such data may then be passed to a storage location (such as a database) and/or used in other processes, as desired.

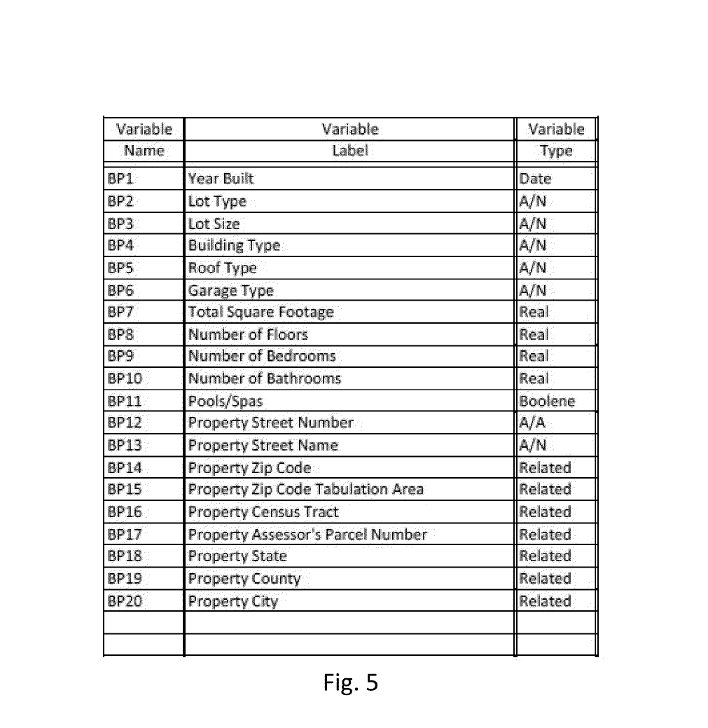

Referring now to exemplary FIG. 5, an exemplary building profile table 500 may be provided. Building profile data may include, for example, the year in which the building was constructed, the type and size of the lot in which the building is located, the type of building (for example, whether the building is residential or commercial), the type of roof the building has (including, for example, the angling or composition of the roof), the type of garage attached to the building (if any), and whether or not the building has any pools, spas, or other large water fixtures. Other data may include more specific numerical details about the building in question, such as the total square footage of the building, its height and/or number of floors, the number of rooms it has, and the number of any specific type of room (such as bedrooms or bathrooms) that it has. Building profile data may also include property location information, such as the property street number and street name, the zip code of the property, the state, county, and city, and any other available records information. Other information may also be available as necessary and as desired.

Data may be stored in the form of primitive-type variables tailored to the specific data element required to be stored. For example, the number of bathrooms the property has may be stored in the form of an integer, while the presence or absence or pools, spas, or other water fixtures may be stored in the form of a Boolean variable. Other data may be stored as appropriate or as desired.

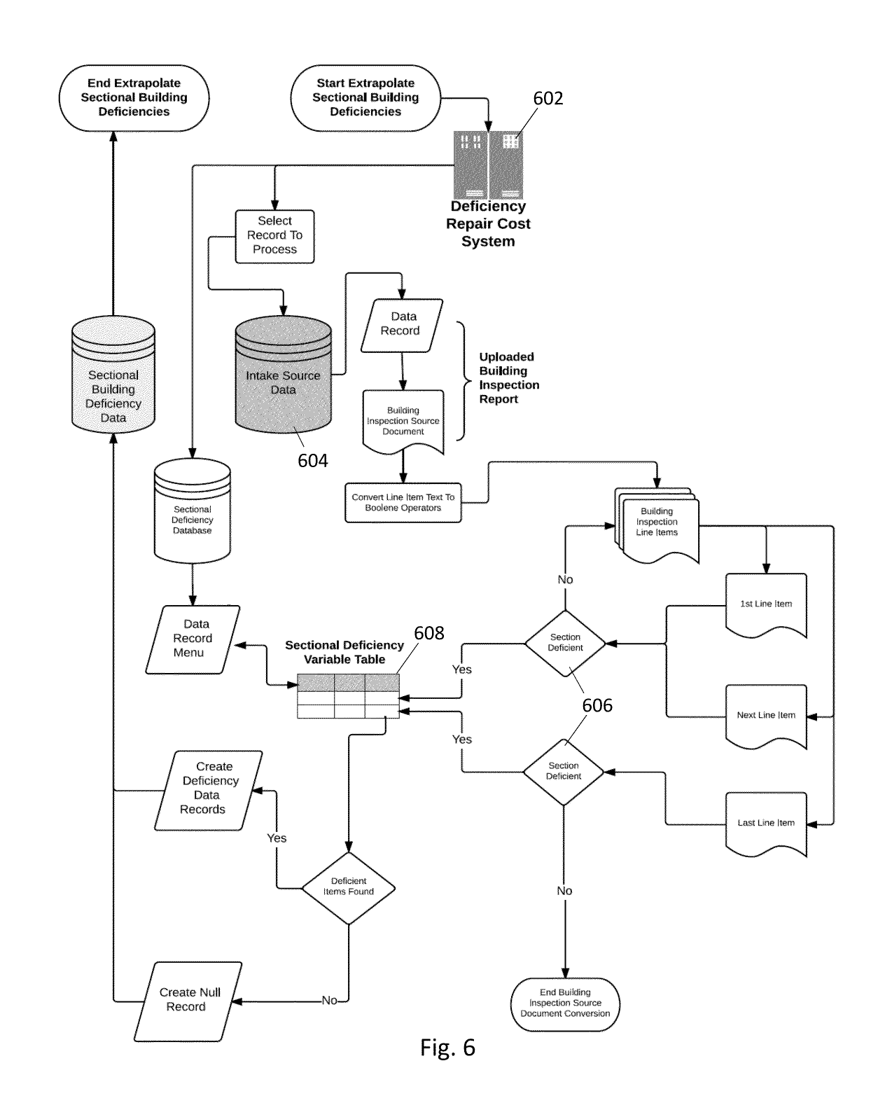

Referring now to exemplary FIG. 6, a flowchart diagram 600 describes an embodiment of a process that may be used to complete the step of extrapolating sectional building deficiencies. A deficiency repair cost system 602 may select from data made available to it, which may include, for example, the intake source data 604 provided by a master user. Intake source data 604 may include the uploaded subjective building inspection report as well as any other data provided by the user or any other data generated by or available to the system. Deficiency cost repair system 602 may parse the intake source data 604 line-by-line and evaluate 606 whether the information from the intake source data 604 indicates that a deficiency exists. If so, the deficiency cost repair system 602 may store information indicating the location of the deficiency and/or characterizing the nature of the deficiency in a sectional deficiency variable table 608. This data may then be passed to a storage location (such as a database) and/or used in other processes, as desired.

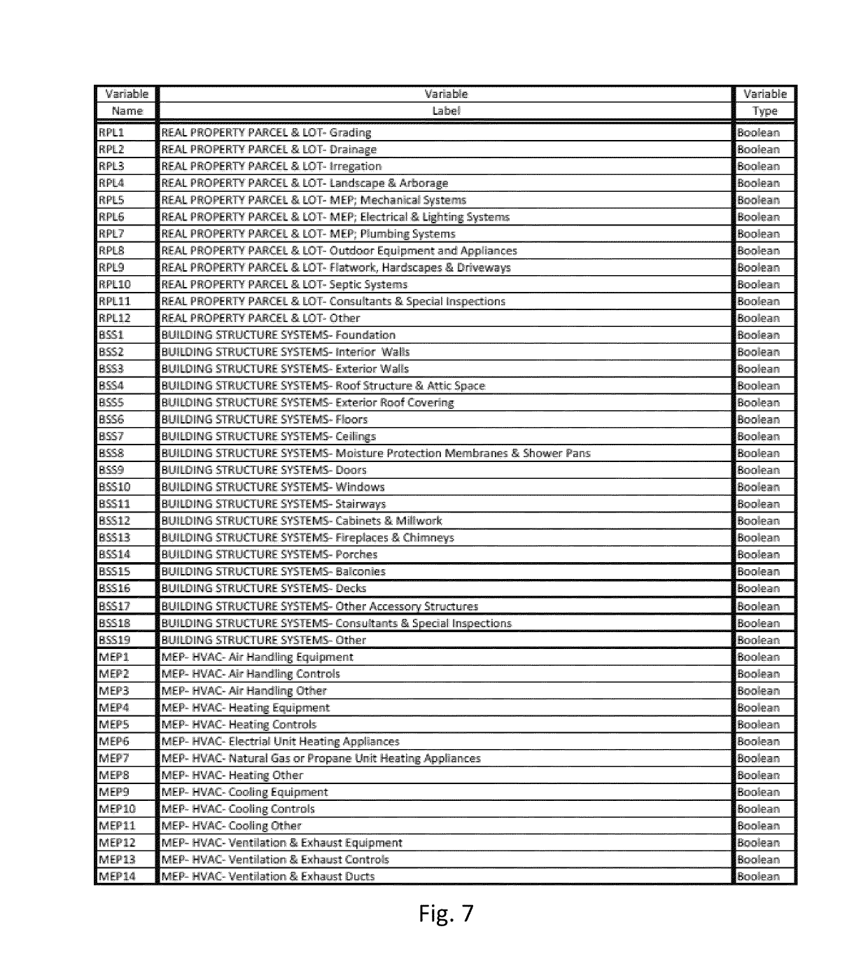

Referring now to exemplary FIG. 7, an exemplary sectional deficiency table 700 may be provided. According to an exemplary embodiment, sectional deficiencies may be identified by category and subcategory. For example, a problem identified with the grading of the property may be identified by the category “REAL PROPERTY PARCEL & LOT” and the subcategory “Grading.” Multiple tiers of categories and subcategories may be envisioned. Identified sectional deficiencies may be stored in the form of Boolean variables, for example as an indication of whether or not a deficiency exists in the identified category, may be stored as any other type of primitive variable, or may be stored as desired.

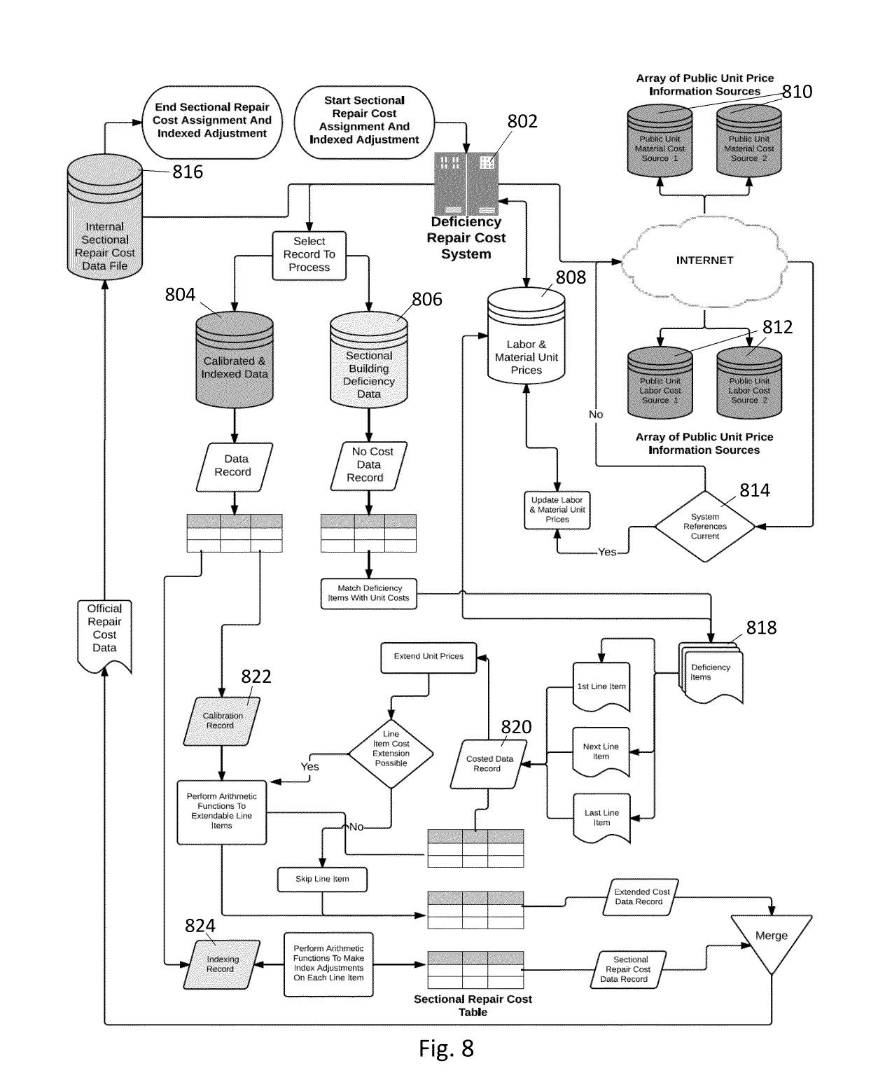

Referring now to exemplary FIG. 8, a flowchart diagram 800 describes an embodiment of a process that may be used to complete the step of sectional repair cost assignment and index adjustment. A deficiency repair cost system 802 may select from data made available to it, which may include, for example, building site components calibration and property index data 804 (as produced by a process similar to that depicted in FIG. 4) or sectional building deficiency data 806 (as produced by a process similar to that depicted in FIG. 6). Other data may also include, for example, current labor and material unit prices 808; such data may be retrieved remotely, for example from publically available price information sources on the Internet 810, 812, may be available on the system 814, or may be available through some combination of the two or another methods.

Deficiency repair cost system 802 may also reference the results of the sectional repair cost assignment and index adjustment step, the internal sectional repair cost data file 816, and may make whatever modifications are necessary based on the information available in the data file. For example, if there are deficiencies in two or more overlapping categories, like an irrigation system and the landscaping, it may be less expensive for the user to fix all such overlapping deficiencies at once than it would be for them to fix each one individually, and the deficiency repair cost system 802 may incorporate information about the other deficiency by reading internal sectional repair cost data file 816 in order to take such considerations into account. Alternatively, it may be more difficult or more expensive to fix certain deficiencies in the presence of other deficiencies, and the deficiency repair cost system 802 may modify its results based on this information as well. Alternatively, other considerations may warrant drawing information from the internal sectional repair cost data file 816.

According to an exemplary embodiment, the deficiency repair cost system 802 may evaluate economies that may be derived from fixing overlapping deficiencies simultaneously. This may be accomplished by, for example, configuring the processor and/or memory with preset known economies contained in material cost sources 810 and labor cost sources 812 that produced any savings. According to an exemplary embodiment, branching logic may evaluate the preset known economies with pairs and combinations of deficiency items 818. The branching logic evaluation process may incorporate the logical operators “AND”, “OR” and “NOT” in its architecture where appropriate, and may step through each deficiency item 818 to determine any overlapping economies that could be achieved by the activity of repairing simultaneously any single deficiency item 818. These results may then be stored in a memory of the deficiency repair cost system 802.

According to another exemplary embodiment, deficiency items 818 may be stored as a series of steps that may be taken in order to remedy the deficiency, and material cost sources 810 and/or labor cost sources 812 may store repair information in terms of these steps. For example, an entry for repair of a deficiency to the irrigation system and an entry for repair of a deficiency to the landscaping may both include a step wherein parts of the lawn or grounds will be dug up in order to repair the deficiency. Deficiency repair cost system 802 may then step through each step of each deficiency item 818 in order to determine whether any of the steps match or are similar. This may allow deficiency repair cost system 802 to derive its own potential economies, if desired.

The deficiency repair cost system 802 may use the sectional building deficiency data 806 to produce a list of deficient items 818. The system 802 may then iterate through this list and combine the deficient item information with labor and material unit price information 808 to produce a costed data record 820. If further extension of this unit price is possible, the system 802 may perform arithmetic functions to the appropriate extendable line items; if further extension is not possible, the system may enter and store the costed data record 820 unmodified. Calibration or model data for the building 822 may be used in order to accurately or more accurately extend the line items; the line item may be paired with the calibration record for the building and the line item extended based on the data available in the calibration record. Location indexing data 824 may also be used in order to modify the costed data records 820; depending on the location and any pertinent details about the location, the details of the costed data records 820 may be adjusted to reflect a more location-specific cost estimate. Other modification to the costed data records 820 may also be appropriate and may also be made. Costed data records 820 may then be merged and added to the internal sectional repair cost data file 816, which may be output to another process or stored as desired.

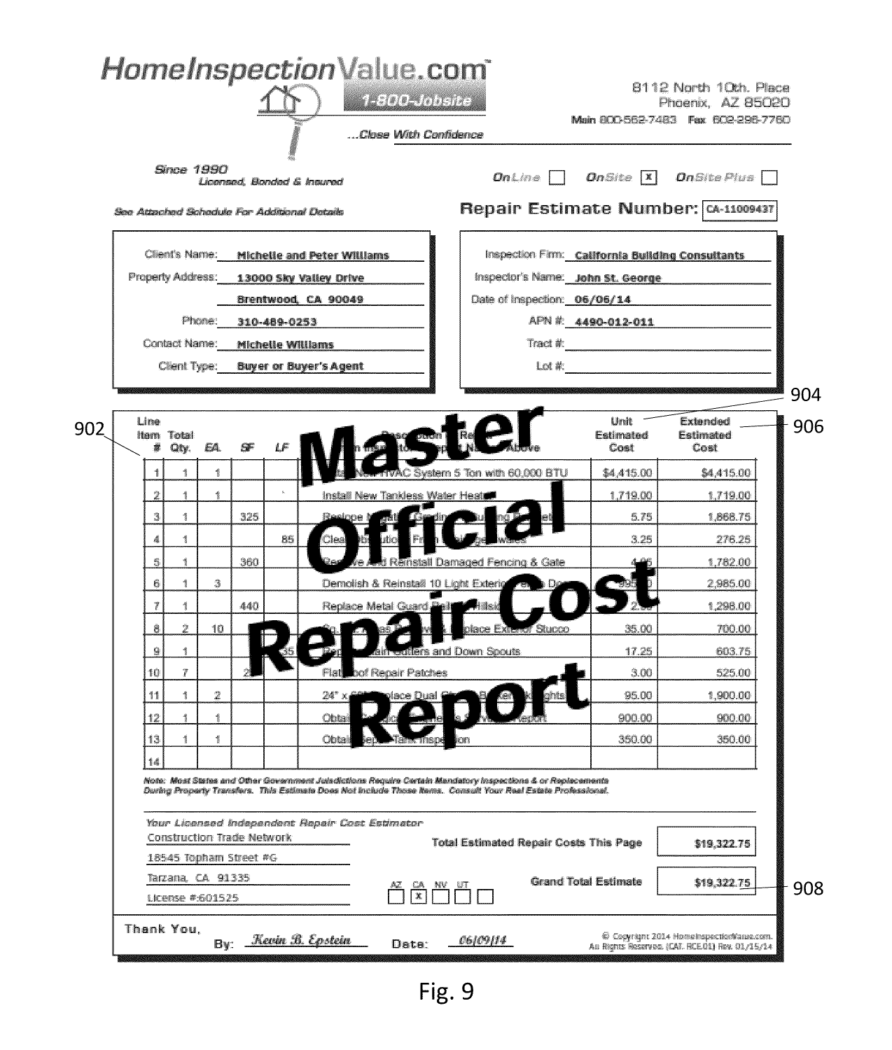

Referring now to exemplary FIG. 9, an exemplary official repair cost report 900 may be provided. A list 902 may be populated with a number of items that would be necessary or useful to a user in order for them to remedy any or all of the deficiencies known or identified in a subjective building inspection report. The list 902 may identify the estimated quantities of items needed, the quantities of deficiencies identified, the square footage or area of the item needed, the length or length footage of the item needed, or the labor costs or man-hours needed to remedy the deficiency. The list may also display the per-unit estimated cost of the item or items 904, the estimated extended cost of the item or items 906, the total estimated cost 908, or any other information desired.

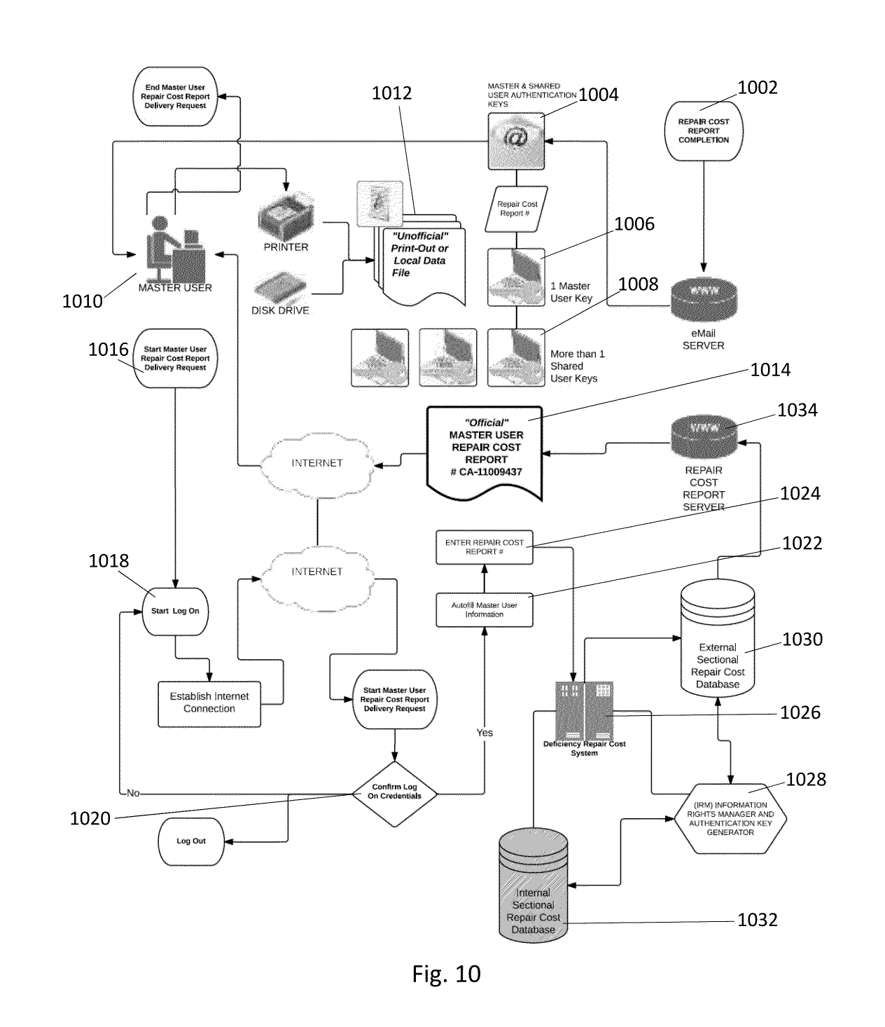

Referring now to exemplary FIG. 10, a flowchart diagram 1000 describes an embodiment of a process for authenticating access to official and unofficial versions of a master version of a repair cost estimate report (“master repair cost estimate report”) 1012, 1014. According to an exemplary embodiment, when a repair cost estimate report is completed 1002, authentication keys 1004, including master authentication keys 1006 and shared authentication keys 1008, may be provided to one or more users. According to an exemplary embodiment, authentication keys 1004 may be emailed when available.

Once a user has an authentication key, the user, such as a master user 1010, may be able to authenticate themselves to an IRM 1028 and thereby obtain access to one or more versions of the completed repair cost estimate report 1002. For example, the master user 1010 may be able to obtain access to an unofficial version of the master repair cost estimate report 1012 and an official version of the master repair cost estimate report 1014.

A user may begin by making a delivery request 1016 for the completed repair cost estimate report 1002. The user may then be prompted to log in 1018. The user may be prompted to confirm their credentials 1020 in order to log in; if they are not able to do so, they may be logged out. A user's credentials may be tied to a user account of the user having an account profile, and thus may be linked to certain account profile information about the user; for example, on logging in, a master user's 1010 status as a master user 1010 may be automatically retrieved 1022. A user may then be prompted to retrieve a completed repair cost estimate report 1002, for example by entering the repair cost report number 1024. This may allow the user to access the deficiency repair cost system 1026 and databases 1030, 1032 linked to the deficiency repair cost system 1026, as well as an IRM 1028 that may authenticate whether or not the user has access to the completed repair cost estimate report 1002 requested by number 1024.

If the IRM 1028 authenticates the user, the user may be provided with access to the completed repair cost estimate report 1002 by a repair cost report server 1034. If the user has authenticated themselves as a master user 1010, the completed repair cost estimate report 1002 provided to the user may be an official version of the master user repair cost estimate report 1014. According to an exemplary embodiment, a master user 1010 may then also be able to print or store unofficial versions of the master user repair cost estimate report 1012.

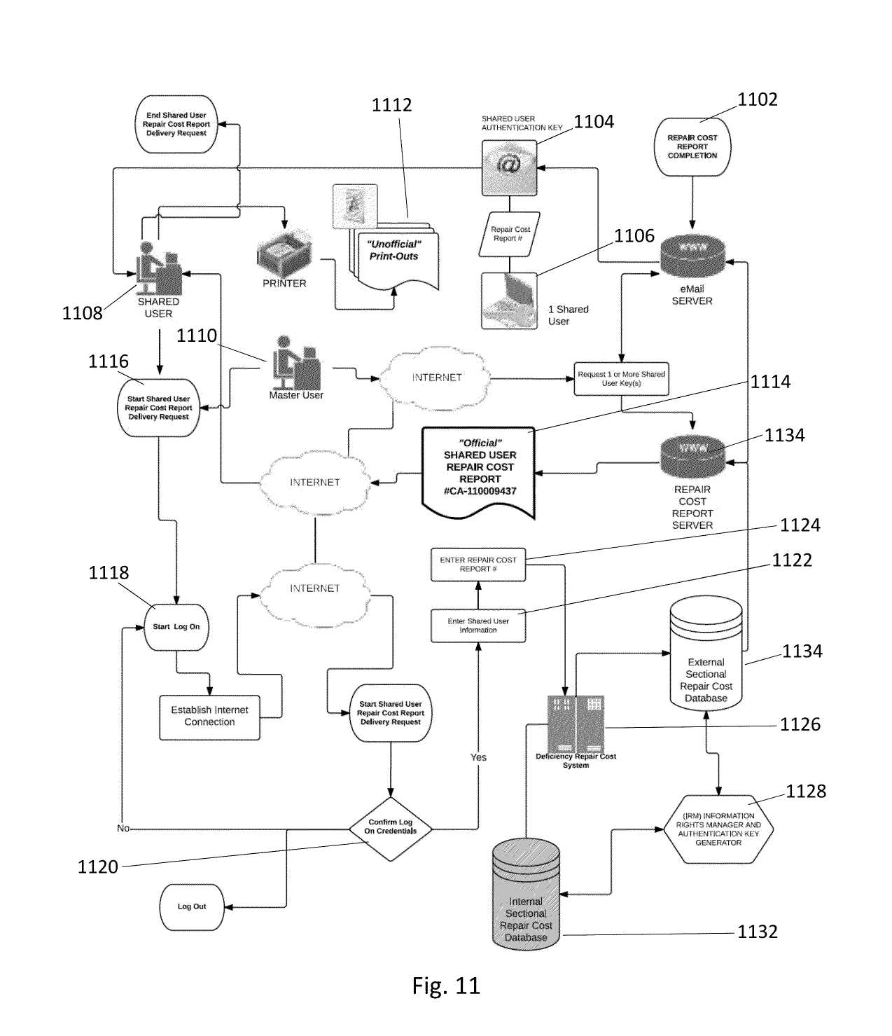

Referring now to exemplary FIG. 11, a flowchart diagram 1100 describes an embodiment of a process for authenticating access to official and unofficial versions of a shared version of a repair cost estimate report (“shared repair cost estimate report”) 1112, 1114. According to an exemplary embodiment, when a repair cost estimate report is completed 1102, authentication keys 1104, including shared authentication keys 1106, may be provided to one or more shared users 1108. A master user 1110 may also receive a shared authentication key 1106, or may be able to make requests for a shared repair cost estimate report 1112, 1114 using a master authentication key. According to an exemplary embodiment, authentication keys 1104 may be emailed when available.

Once a user has an authentication key, the user, such as a shared user 1108, may be able to authenticate themselves to an IRM 1128 and thereby obtain access to one or more versions of the completed repair cost estimate report 1102. For example, the shared user 1108 may be able to obtain access to an unofficial version of the shared repair cost estimate report 1112 and an official version of the shared repair cost estimate report 1114.

A user may begin by making a delivery request 1116 for the completed repair cost estimate report 1102. The user may then be prompted to log in 1118. The user may be prompted to confirm their credentials 1020 in order to log in; if they are not able to do so, they may be logged out. A user's credentials may be tied to a user account of the user having an account profile, and thus may be linked to certain account profile information about the user; for example, on logging in, a shared user's 1108 status as a shared user 1108 may be automatically retrieved 1122. A user may then be prompted to retrieve a completed repair cost estimate report 1102, for example by entering the repair cost report number 1124. This may allow the user to access the deficiency repair cost system 1126 and databases 1130, 1132 linked to the deficiency repair cost system 1126, as well as an IRM 1128 that may authenticate whether or not the user has access to the completed repair cost estimate report 1102 requested by number 1124.

If the IRM 1128 authenticates the user, the user may be provided with access to the completed repair cost estimate report 1102 by a repair cost report server 1134. If the user has authenticated themselves as a shared user 1108, or has requested a shared repair cost estimate report 1112, 1114 as a master user 1110, the completed repair cost estimate report 1102 provided to the user may be an official version of the shared repair cost estimate report 1114. According to an exemplary embodiment, the user may then also be able to print unofficial versions of the shared user repair cost estimate report 1112.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for generating repair estimate reports, comprising:
storing, on a memory, building data regarding at least one building, wherein the building data comprises subjective building inspection data, physical building data, and property location data;
generating, on a memory and with a processor, from the subjective building inspection data, sectional deficiency data comprising at least one of a sectional deficiency and a potential sectional deficiency;
generating, on a memory and with a processor, from the building data, a model of the at least one building;
generating, on a memory and with a processor, from the building data, a plurality of index factors;
generating, on a memory and with a processor, using at least one of the sectional deficiency data, the model of the at least one building, and the plurality of index factors, a plurality of repair cost estimate reports, comprising a master repair cost estimate report and a shared repair cost estimate report, and comprising an official repair cost estimate report and an unofficial repair cost estimate report;
storing, on a memory, the plurality of repair cost estimate reports;
storing, on a memory, a credential of a user authorized to access the official repair cost estimate report;
receiving a request for the official repair cost estimate report containing the credential of the user;
providing a repair cost estimate report viewer application to the user; and
sending a notification to the repair cost estimate report viewer application;
wherein the notification activates the repair cost estimate report viewer application to cause the official repair cost estimate report to display on the repair cost estimate report viewer application.

2. The method of claim 1, wherein building data further comprises building code data.

3. The method of claim 1, further comprising:
storing, on a memory, at least one of building material standards and building labor standards; and
wherein the step of generating a plurality of repair cost estimate reports further comprises using the at least one of building material standards and building labor standards.

4. The method of claim 1, wherein the plurality of index factors comprise location-specific adjustments.

5. The method of claim 1, wherein the unofficial repair cost estimate report comprises a permanent indication that the unofficial repair cost estimate report is an unofficial document.

6. The method of claim 1, wherein the credential of the user authorized to access the official repair cost estimate report is stored as a part of a user account of the user, the user account of the user further comprising an indication that the user is subscribed to a repair cost estimate report service.

7. The method of claim 1, further comprising:
receiving a request for the unofficial repair cost estimate report containing a credential of a user; and
transmitting the unofficial repair cost estimate report to a user.

8. The method of claim 7, further comprising:
determining at least one of the preferences of a user and the level of service of a user; and
limiting the content of the unofficial repair cost estimate report based on the at least one of the preferences of the user and the level of service of the user.

9. The method of claim 1, wherein access to the official repair cost estimate report is limited by an access control, said access control preventing the official repair cost estimate report from being read by an application other than the repair cost estimate report viewer application; and
wherein the repair cost estimate report viewer application restricts duplication of the official repair cost estimate report.

10. The method of claim 1, further comprising:
identifying, from at least one of the subjective building inspection data and the sectional deficiency data, a category of sectional deficiency or category of potential sectional deficiency of the building;
storing, in a memory, contact information for each of a plurality of building repair professionals, said contact information including an area of expertise for each of the plurality of building repair professionals, each area of expertise corresponding to a category of sectional deficiency or category of potential sectional deficiency;
identifying at least one building repair professional having an area of expertise matching the identified category of sectional deficiency or identified category of potential sectional deficiency;
generating, with a processor, a repair cost estimate report including the contact information of the identified at least one building repair professional.

11. A computer program product embodied on a non-transitory computer readable medium, comprising code executable by a computer comprising a processor and a memory, to cause the computer to carry out the following steps:
storing, on a memory, building data regarding at least one building, wherein the building data comprises subjective building inspection data, physical building data, and property location data;
generating, on a memory and with a processor, from the subjective building inspection data, sectional deficiency data comprising at least one of a sectional deficiency and a potential sectional deficiency,
generating, on a memory and with a processor, from the building data, a model of the at least one building;
generating, on a memory and with a processor, from the building data, a plurality of index factors;
generating, on a memory and with a processor, using at least one of the sectional deficiency data, the model of the at least one building, and the plurality of index factors, a plurality of repair cost estimate reports, comprising a master repair cost estimate report and a shared repair cost estimate report, and comprising an official repair cost estimate report and an unofficial repair cost estimate report;
storing, on a memory, the plurality of repair cost estimate reports;
storing, on a memory, a credential of a user authorized to access the official repair cost estimate report;
receiving a request for the official repair cost estimate report containing the credential of the user;
providing a repair cost estimate report viewer application to the user; and
sending a notification to the repair cost estimate report viewer application;
wherein the notification activates the repair cost estimate report viewer application to cause the official repair cost estimate report to display on the repair cost estimate report viewer application.

12. The computer program product of claim 11, wherein building data further comprises building code data.

13. The computer program product of claim 11, further comprising code executable to cause the computer to carry out the following steps:
storing, on a memory, at least one of building material standards and building labor standards; and
wherein the step of generating a plurality of repair cost estimate reports further comprises using the at least one of building material standards and building labor standards.

14. The computer program product of claim 11, wherein the plurality of index factors comprise location-specific adjustments.

15. The computer program product of claim 11, wherein the unofficial repair cost estimate report comprises a permanent indication that the unofficial repair cost estimate report is an unofficial document.

16. The computer program product of claim 11, wherein the credential of the user authorized to access the official repair cost estimate report is stored as a part of a user account of the user, the user account of the user further comprising an indication that the user is subscribed to a repair cost estimate report service.

17. The computer program product of claim 11, further comprising code executable to cause the computer to carry out the following steps:
receiving a request for the unofficial repair cost estimate report containing a credential of a user; and
transmitting the unofficial repair cost estimate report to a user.

18. The computer program product of claim 17, further comprising code executable to cause the computer to carry out the following steps:
determining at least one of the preferences of a user and the level of service of a user; and
limiting the content of the unofficial repair cost estimate report based on the at least one of the preferences of the user and the level of service of the user.

19. The computer program product of claim 11, wherein access to the official repair cost estimate report is limited by an access control, said access control preventing the official repair cost estimate report from being read by an application other than the repair cost estimate report viewer application; and
wherein the repair cost estimate report viewer application restricts duplication of the official repair cost estimate report.

20. The computer program product of claim 11, further comprising code executable to cause the computer to carry out the following steps:
identifying, from at least one of the subjective building inspection data and the sectional deficiency data, a category of sectional deficiency or category of potential sectional deficiency of the building;
storing, in a memory, contact information for each of a plurality of building repair professionals, said contact information including an area of expertise for each of the plurality of building repair professionals, each area of expertise corresponding to a category of sectional deficiency or category of potential sectional deficiency;
identifying at least one building repair professional having an area of expertise matching the identified category of sectional deficiency or identified category of potential sectional deficiency; and
generating, with a processor, a repair cost estimate report including the contact information of the identified at least one building repair professional.
